(19) United States
(12) Patent Application Publication
(10) Pub. No.: US 2026/0244589 A1
(43) Pub. Date: Aug. 20, 2026

(54) PLUGGABLE PCIE CONNECTORS

(71) Applicant: Aivres Systems Inc., San Jose, CA (US)

(72) Inventor: SHI-WEI WANG, New Taipei City (TW)

(21) Appl. No.: 19/058,384

(22) Filed: Feb. 20, 2025

(51) Int. Cl. G06F 13/42

(52) U.S. Cl. CPC G06F 13/4221; G06F 2213/0026

(57) ABSTRACT

Systems, devices, and methods for managing peripheral component interconnect express (PCIe) connectors are provided, e.g., for connecting PCIe cards to computer boards. In one aspect, a device includes a peripheral component interconnect express (PCIe) connector configured to be electronically connected to a peripheral component interconnect express (PCIe) card. The device also includes a PCIe adapter configured to be electronically connected to the PCIe connector, and the PCIe adapter is further configured to be electronically connected to the computer board.

### BACKGROUND

With the development of server computing, sometimes a motherboard of a server may need to be shipped back to the manufacture company to replace and/or fix peripheral component interconnect express (PCIe) connectors during maintenance operation of the server.

### SUMMARY

The present disclosure provides devices, apparatus, and methods for managing pluggable PCIe connectors, e.g., for assembling and/or disassembling from a server motherboard.

One aspect of the present disclosure features a device that includes a peripheral component interconnect express (PCIe) connector configured to be electronically connected to a peripheral component interconnect express (PCIe) card. The device also includes a PCIe adapter configured to be electronically connected to the PCIe connector, where the PCIe adapter is further configured to be electronically connected to a computer board.

In some implementations, the PCIe adapter includes first contacts, and where a first contact includes a first end and a second end along a first direction, and where the first end of the first contact is configured to be electronically connected to a contact pad of the computer board, and the second end of the second contact is configured to be electrically connected to a contact pad of the PCIe connector.

In some implementations, the first end of the first contact extends along a second direction different from the first direction.

In some implementations, the first contact has an L shape.

In some implementations, the PCIe adapter further includes two connection structures on opposite ends of the PCIe adapter along a second direction perpendicular to the first direction; and a first housing structure surrounding the first contacts and the two connection structures.

In some implementations, the two connection structures are configured to secure the PCIe adapter on the computer board.

In some implementations, first ends of the first contacts and the two connection structures are soldered onto and electrically connected to corresponding contact pads of the computer board.

In some implementations, the first contacts include a conductive material, and where the first housing structure includes an insulating material.

In some implementations, a number of the first contacts is in a range between 16 to 164.

In some implementations, the number of the first contacts matches a number of the corresponding pads of the computer board.

In some implementations, the first contacts are arranged into two rows extending along a second direction, and the two rows are separated from each other along a third direction perpendicular to the first direction and the second direction.

In some implementations, the PCIe connector includes second contacts, and where a second contact includes a first receptor, a conductive layer, and a second receptor that are arranged along the first direction, where conductive layers of the second contacts are isolated from each other, and where the first receptor and the second receptor are connected to opposite ends of the conductive layer along the first direction.

In some implementations, the PCIe connector further includes a second housing structure surrounding the second contacts.

In some implementations, a number the second contacts of the PCIe connector is no greater than a number of the first contacts of the PCIe adapter.

In some implementations, the second contacts are arranged into two rows extending along a second direction, and where the two rows of the second contacts are separated from each other along a third direction perpendicular to the first direction and the second direction.

In some implementations, the conductive layer of the second contact includes a conductive material, and where the first receptor of the second contact includes a first insulating material, and the second receptor of the second contact includes a second insulating material.

In some implementations, the second receptor of the second contact is configured to be connected to a corresponding second end of the first contact of the PCIe adapter, and where the conductive layer of the second contact is configured to be electrically connected to the corresponding second end of the first contact of the PCIe adapter when the second receptor is connected to the corresponding second end of the first contact.

In some implementations, the second receptor of the second contact has a female structure, and the second end of the first contact has a male structure.

In some implementations, the second receptor of the second contact has a male structure, and the second end of the first contact has a female structure.

In some implementations, the PCIe card includes a plurality of connection pins, and where first receptors of the second contacts of the PCIe connector are configured to be connected to the plurality of connection pins of the PCIe card.

In some implementations, each of the plurality of connection pins of the PCIe card is in contact with a corresponding conductive layer of the second contact of the PCIe connector, and where the PCIe card is electrically coupled to the computer board through the first contacts of the PCIe adapter and the second contacts of the PCIe connector.

In some implementations, each of the plurality of connection pins of the PCIe card is electrically coupled to a corresponding second end of the first contact of the PCIe adapter through a corresponding conductive layer of the second contact of the PCIe connector.

Another aspect of the present disclosure features a method of assembling a PCIe card onto the computer board, the method includes connecting a PCIe adapter to a PCIe interface of a computer board; connecting a PCIe connector to the PCIe adapter; and connecting a PCIe card onto the computer board by inserting conductive pins of the PCIe card into the PCIe connector.

In some implementations, connecting the PCIe adapter to the PCIe interface of the computer board includes soldering first contacts of the PCIe adapter to corresponding contact pads of the PCIe interface of the computer board, such that the first contacts of the PCIe adapter are electrically connected to the corresponding contact pads of the PCIe slot of the computer board.

In some implementations, connecting the PCIe adapter to the PCIe interface of the computer board further includes soldering two connection structures of the PCIe adapter to the PCIe interface of the computer board to secure the PCIe adapter onto the PCIe slot.

In some implementations, connecting the PCIe connector to the PCIe adapter includes inserting each of the first contacts of the PCIe adapter into a corresponding receptor of a second contact of the PCIe connector, where the first contact of the PCIe adapter is electrically connected to a corresponding conductive layer of the second contact of the PCIe connector.

In some implementations, each of the conductive pins of the PCIe card is electrically coupled to a corresponding first contact of the PCIe adapter through the corresponding conductive layer of the second contact of the PCIe connector.

A further aspect of the present disclosure features a system. The system includes a computer board having a PCIe interface; and a PCIe device. The PCIe device includes a PCIe connector configured to be electronically connected to a PCIe card; and a PCIe adapter configured to be electronically connected to the PCIe connector, where the PCIe adapter is further configured to be electronically connected to the PCIe interface of the computer board.

The details of one or more implementations of the subject matter of this specification are set forth in the Detailed Description, the claims, and the accompanying drawings. Other features, aspects, and advantages of the subject matter will become apparent to those of ordinary skill in the art from the Detailed Description, the claims, and the accompanying drawings.

### DESCRIPTION OF DRAWINGS

FIG. 1A illustrates a block diagram of an example computer board including PCIe slots.

FIG. 1B illustrates a top view of an example PCIe slot.

FIG. 2 is a perspective view of an example PCIe card.

FIG. 3A is a perspective view of an example PCIe adapter.

FIG. 3B is a side view of a component of an example PCIe adapter of FIG. 3A.

FIG. 3C is a perspective view of components of an example PCIe adapter of FIG. 3A.

FIG. 4A shows a top view of assembling a PCIe adapter of FIG. 3A onto a PCIe slot of FIGS. 1A-1B.

FIG. 4B shows a cross section view of assembling a PCIe adapter of FIG. 4A onto a PCIe slot of FIGS. 1A-1B.

FIG. 5A is a perspective view of an example PCIe connector.

FIG. 5B is a side view of a component of the example PCIe connector of FIG. 5A.

FIGS. 6A-6B show steps of assembling a PCIe connector of FIGS. 5A-5B with a PCIe adapter of FIG. 3A.

FIG. 7 is a flowchart of an example process of a method for assembling a PCIe card on a computer board.

FIG. 8 illustrates a block diagram of a computer system.

Like reference numbers and designations in the various drawings indicate like elements.

### DETAILED DESCRIPTION

During the integration and service phase of server computing, operators might need to replace and change a Peripheral Component Interconnect Express (PCIe) card on a server motherboard to optimize server performance. In some implementations, the PCIe card is coupled to the motherboard through a PCIe connector that is soldered onto the motherboard, which may cause problems during the integration and service phase of server computing. For example, during the integration phase of server computing, the motherboard needs to be shipped back to the manufacturer to change the types of PCIe connectors for different types of PCIe cards. In other words, the PCIe connector in the design needs to be swapped for different types of PCIe cards. During the service phase, the motherboard also needs to be shipped back to the manufacturer to fix faulty PCIe connectors. Shipping the motherboard to the manufacturer during the integration and service phase of server computing may lead to long server downtime and high maintenance costs. Therefore, a device that can reduce server downtime during the integration and service phase with a simplified process is desirable.

In one or more implementations of the present disclosure, an example device for connecting a PCIe card to a computer board is provided. The device includes a peripheral component interconnect express (PCIe) connector configured to be electronically connected to a peripheral component interconnect express (PCIe) card. The device also includes a PCIe adapter configured to be electronically connected to the PCIe connector that can be pluggable from the PCIe adapter, where the PCIe adapter is further configured to be electronically connected to and soldered on a computer board.

Implementations of the present disclosure can provide one or more of the following technical advantages and/or benefits. First, the PCIe connector according to the present disclosure is pluggable and can be removed from the computer board through the PCIe adapter. The pluggable PCIe connector allows an operator to change and swap different types of PCIe connectors that are connected to the computer board during the integration phase of server computing. In other words, the pluggable PCIe connector allows an operator to connect different types of PCIe cards to the computer board without shipping the computer board to the manufacturer. Second, the pluggable PCIe connector simplifies the service phase of server computing. In other words, the operator can change a faulty PCIe connector without shipping the computer board to the manufacturer. Third, a PCIe adapter (e.g., 64 contacts) can accommodate different lengths/types of PCIe adapters (e.g., 36 contacts, 64 contacts, 98 contacts, or 164 contacts) and accordingly different types of PCIe cards (e.g., PCIe X1, PCIe X4, PCIe X8, or PCIe X16), which increases the flexibility of the motherboard soldered with the PCI adapter. Thus, an operator can freely change different types of PCIe adapters on the PCIe adapter for different types of PCIe cards based on needs.

Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

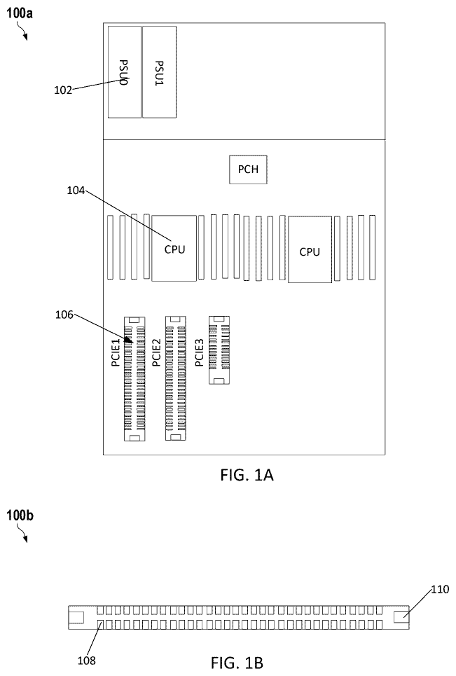

FIG. 1A illustrates a block diagram of an example computer board 100a. As shown in FIG. 1A, the computer board 100a can be a motherboard of a server computer. The computer board 100a includes one or more power supply units (PSUs) 102. The one or more PSUs 102 are used to supply power to the computer board 100a. The computer board 100a also includes at least one central processing unit (CPU) 104. The CPU 104 is configured to handle and executes both hardware and software instructions running on the server computer. As shown in FIG. 1A, the computer board 100a also includes one or more peripheral component interconnect express (PCIe) slots 106. The one or more PCIe slots 106 can be used to mount various hardware components (or PCIe devices) including but not limit to, a graphic processing unit (GPU), a memory unit, a sound card unit, and/or a network card. The one or more PCIe slots 106 have different lengths with different number of contacts (e.g., conductive pins or pads) that can be fit with different types (or lengths) of PCIe connectors and accordingly different types (or lengths) PCIe cards. For example, as illustrated in FIG. 1A, each of PCIe slot 1, PCIe slot 2 has 32 contacts, while PCIe slot 3 has 18 contacts. The one or more PCIe slots 106 are powered by the PSUs 102 and coupled to the CPU 104. In some implementations, the CPU 104 is configured to send instructions to the various hardware components through the PCIe slots 106. In some implementations, the CPU 104 is configured to receive data from the various hard components through the PCIe slots 106.

FIG. 1B illustrates a top view of a PCIe slot 100b. The example PCIe slot 100b can be, e.g., a PCIe slot 106 of the computer board 100a of FIG. 1A. As shown in FIG. 1B, the PCIe slot 100b can include a plurality of contact pads 108. The contact pads 108 are configured to be electrically coupled to the CPU 104 of the computer board 100a of FIG. 1A. In some implementations, the contact pads 108 are configured to receive and send signals from and to the CPU 104. The PCIe slot 100b can include various number of contact pads 108 based on different types of application. A number of contact pads of the PCIe slot 100b can be in a range between 8 to 164 or more. For example, as shown in FIG. 1B, the PCIe slot 100b can be a PCIe X1 type with 36 contact pads on two rows, each row including 18 contact pads. In some implementations, a PCIe slot can be a PCIe X4 type with 64 contact pads on two rows, each row including 32 contact pads. In some implementations, a PCIe slot can be a PCIe X8 type with 98 contact pads on two rows, each row including 49 contact pads. In some implementations, a PCIe slot can be a PCIe X16 type with 164 contact pads on two rows, each row including 82 contact pads. In some implementations, as shown in FIG. 1B, the contact pads 108 of the PCIe slot 100b are arranged into two rows extending along a horizontal direction. The contact pads 108 are separated from each other by a dielectric material along the horizontal direction perpendicular to the horizontal direction.

The PCIe slot 100b can also include one or more (e.g., two as shown in FIG. 1B) ground contacts 110 on opposite ends of the PCIe slot 100b along the horizontal direction. In some implementations, the two ground contacts 110 can be used as a ground contact for a hardware component that is mounted onto the PCIe slot 100b. In some implementations, the two ground contacts 110 can be used as positioning contacts for a user (e.g., a human hand or a robot hand) to mount the hardware component onto the PCIe slot 100b.

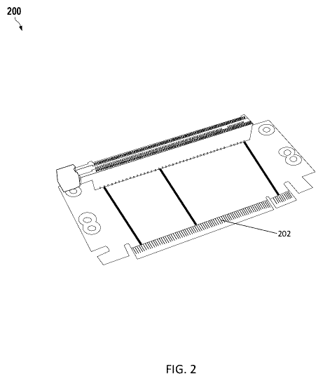

FIG. 2 is a perspective view of an example PCIe card 200. The PCIe card 200 can be a hardware component that is used to perform different functions for the server computer. The PCIe card 200 is coupled to the CPU 104 of the computer board 100a of FIG. 1A through the PCIe slot (e.g., the PCIe slot 106 of FIG. 1A or the PCIe slot 100b of FIG. 1B). In some implementations, the PCIe card 200 can be a graphic processing unit (GPU), a memory unit, a sound card unit, and a network card or any other types of hardware component that is coupled to the CPU 104 through the PCIe slot. As shown in FIG. 2, the PCIe card 200 includes connection pins 202. In some implementations, the connection pins 202 are used as signal transfer channels between the PCIe card 200 and the CPU 104 through the PCIe slot (e.g., the PCIe slot 106 of FIG. 1A or the PCIe slot 100b of FIG. 1B). In some examples, the number of connection pins 202 ranges, e.g., from 8 to 82, depending on the application. In some implementations, the connection pins 202 are coated with a conductive material such as gold or copper. In some implementations, the connection pins 202 are arranged in a row along the horizontal direction, where the connection pins 202 are separated from each other by a dielectric material.

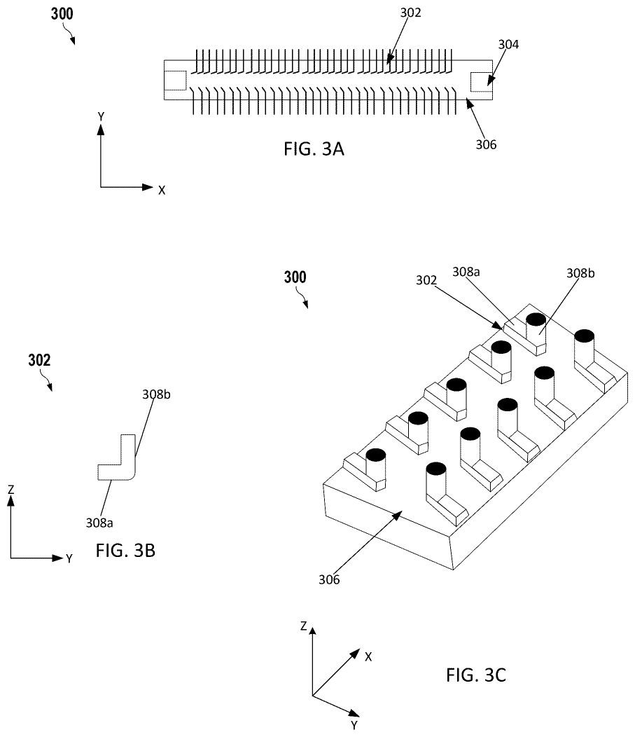

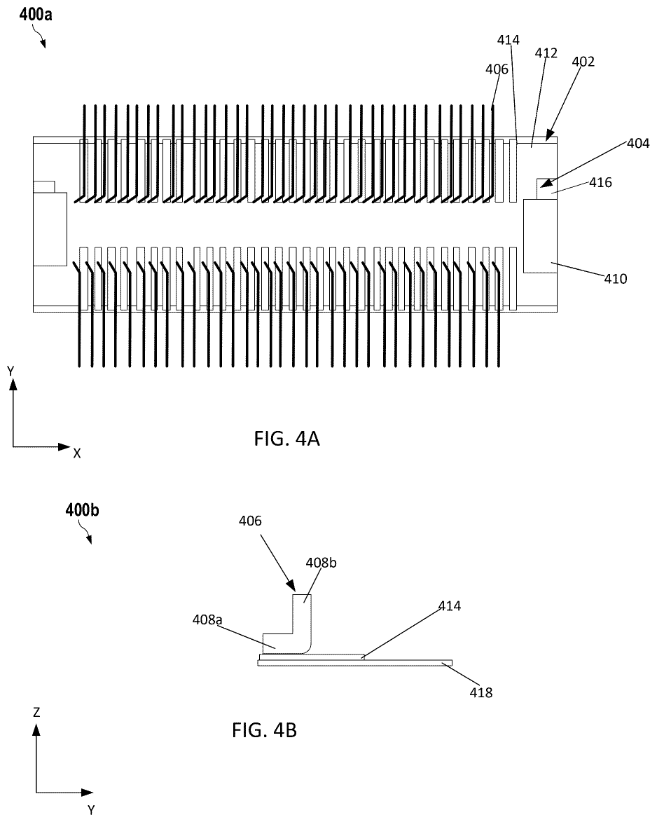

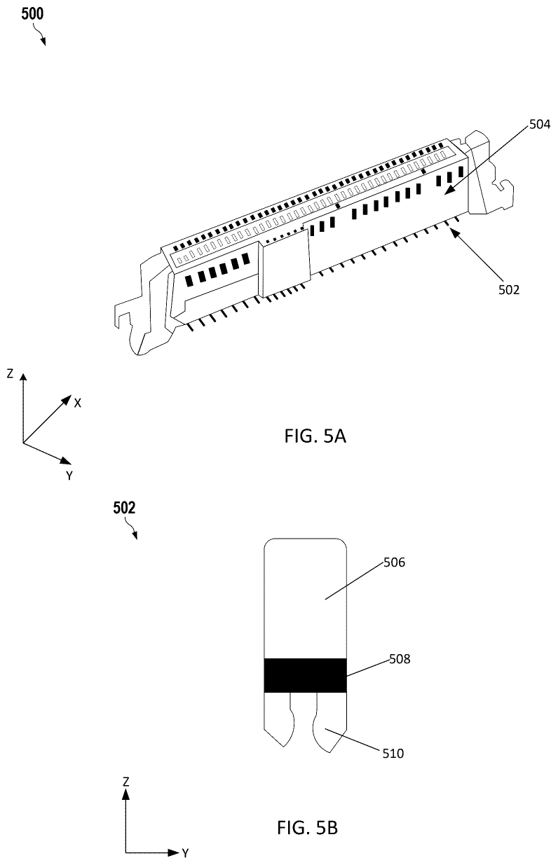

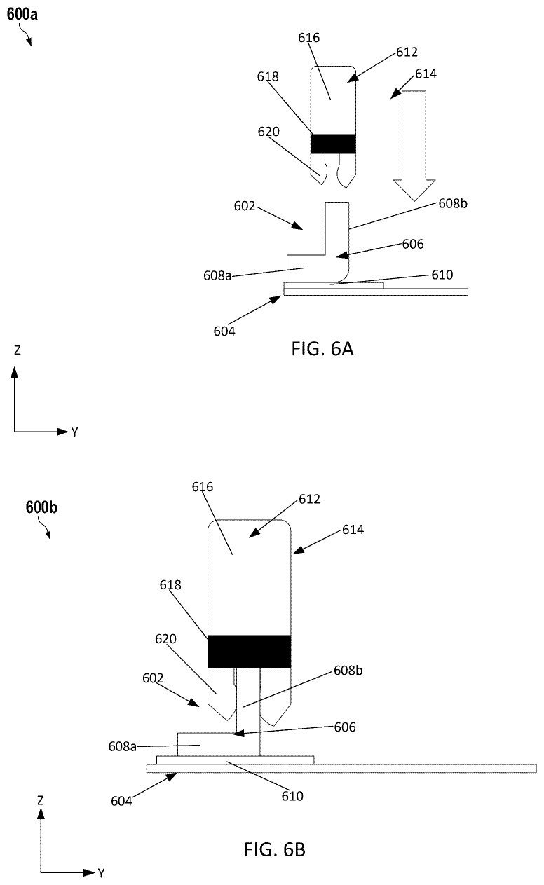

As discussed with further details below, to connect a PCIe card (e.g., the PCIe card 200 of FIG. 2) to a PCIe slot (e.g., the PCIe slot 106 of FIG. 1A or 100b of FIG. 1B), the PCIe card can be inserted into a PCIe connector (e.g., as illustrated with further details in FIGS. 5A-5B and 6A-6B). The PCIe connector (with the PCIe card) can be plugged into a PCIe adapter (e.g., as illustrated with further details in FIGS. 3A-3B) that can be connected to the PCIe slot (e.g., as illustrated with further details in FIGS. 4A-4B).

FIG. 3A is a perspective view of an example PCIe adapter 300. As shown in FIG. 3A, the PCIe adapter 300 includes first contacts 302, one or more (e.g., two) connection structures 304, and a first housing structure 306.

In some implementations, the first contacts 302 includes a conductive material including but not limit to W, Au, Ag, Cu or any other suitable conductive material thereof. In some implementations, a number of the first contacts 302 is in a range, e.g., between 16 to 164 depending on different applications. In some implementations, the number of the first contacts 302 matches a number of the contact pads 108 of the PCIe slot 100b of FIG. 1B. In some implementations, the first contacts are arranged in two rows extending along a first direction (e.g., the X direction) and the two rows are separated from each other along a second direction (e.g., the Y direction) perpendicular to the first direction.

In some implementations, as shown in FIG. 3A, the two connection structures 304 can include a conductive material including but not limit to W, Au, Ag, Cu or any other suitable conductive material thereof. In some implementations, the first housing structure 306 includes an insulating material including but not limited to plastic, ceramic or any other suitable material thereof. As shown in FIG. 3A, the two connection structures 304 are on opposite ends of the PCIe adapter 300 along the first direction. The first housing structure 306 encloses the first contacts 302 and the two connection structures 304. In some implementations, the PCIe adapter 300 is electrically connected to (e.g., soldered with) the PCIe slot 106 of the computer board 100a, and the two connection structures 304 are configured to secure the PCIe adapter 300 on the PCIe slot 106 of the computer board 100a. In some implementations, each of the two connection structures 304 is coupled to a corresponding ground contact 100 of the PCIe slot 100b of FIG. 1B. In some implementations, the two connection structures 304 can be used as a ground contact for the PCIe card (e.g., the PCIe card 200 of FIG. 2) that is connected to the computer board (e.g., the computer board 100a of FIG. 1A) through the PCIe adapter 300. In some implementations, the first housing structure 306 is configured to integrate the first contacts 302 and the two connection structures 304 into a single piece. In some implementations, the first housing structure 306 is configured to provide structure support for the PCIe adapter 300.

In some implementations, the two connection structures 304 can include an insulating material including but not limited to plastic, ceramic or any other suitable material thereof. In some implementations, the two connection structures 304 are connected to the ground contacts 110 of a PCIe slot, where the two connection structures 304 are configured to secure the PCIe adapter 300 on the PCIe slot (e.g., the PCIe slot 106 of the computer board 100a of FIG. 1A).

FIG. 3B is a side view of one of the first contacts 302. As shown in FIG. 3B, the first contact 302 includes a first end 308a and a second end 308b. As shown in FIG. 3B, the first end 308a extends along the second direction and the second end 308b extends along a third direction (e.g., the Z direction) perpendicular to the first direction and the second direction. In some implementations, a cross-section of the first contact 302 perpendicular to the first direction has an L shape.

FIG. 3C is a perspective view of components of the PCIe adapter 300. As shown in FIG. 3C, the first contacts 302 are arranged into two rows extend along the first direction. The first end 308a of each of the first contacts 302 extends along the second direction, where the second end 308b of each of the first contacts 302 extends along the third direction. As shown in FIG. 3C, the first housing structure 306 is integrated with the first contacts 302 into a single body, which can improve the structural integrity of the PCIe adapter 300.

FIG. 4A shows a top view 400a of assembling a PCIe adapter of FIG. 3A onto the PCIe slot 106 of FIG. 1A of the PCIe slot 100b of FIG. 1B. As shown in FIG. 4A, a PCIe adapter 402 is electronically connected to a PCIe slot 404 of a computer board. In some implementations, the PCIe adapter 402 can be similar to, or same as the PCIe adapter 300 of FIG. 3A. The PCIe slot 404 can be similar to, or same as, the PCIe slot 106 of FIG. 1A or the PCIe slot 100b of FIG. 1B.

The PCIe adapter 402 includes first contacts 406. Each of the first contacts 406 includes a first end 408a extend along the second direction and a second end 408b extend along the third direction. In some implementations, the PCIe adapter 402 includes two connection structures 410 on opposite ends of the PCIe adapter 402 along the first direction. In some implementations, the PCIe adapter 402 further includes a first housing structure 412 enclosing the first contacts 406 and the two connection structures 410.

In some implementations, the PCIe slot 404 includes contact pads 414 and two ground contacts 416. In some implementations, a number of the first contacts 406 of the PCIe adapter 402 matches (e.g., one to one) a number of the contact pads 414 of the PCIe slot 404. In some implementations, the first end 408a of each of the first contacts 406 of the PCIe adapter 402 are configured to be electronically connected to a corresponding contact pad 414 of the PCIe slot 404. In some implementations, the first end 408a of the first contact 406 is soldered onto the corresponding contact pad 414 of the PCIe slot 404.

In some implementations, the two connection structures 410 of the PCIe adapter 402 are soldered onto and the two ground contacts 416 of the PCIe slot 404. The two connection structures 410 are configured to secure the PCIe adapter 402 onto the PCIe slot 404.

FIG. 4B shows a cross section view 400b of assembling a PCIe adapter 402 of FIG. 4A onto the PCIe slot 106 of FIG. 1A of the PCIe slot 100b of FIG. 1B. As shown in FIG. 4B, each of the contact pads 414 of the PCIe slot 404 is printed onto the computer board 418. The first end 408a of each of the first contacts 406 of the PCIe adapter 402 is electrically connected to the corresponding contact pad 414 of the PCIe slot 404 along the third direction. The second end 408b of each of the first contacts 406 of the PCIe adapter 402 extends vertically along the third direction.

FIG. 5A is a perspective view of an example PCIe connector 500. The PCIe connector 500 is configured to be electronically connected to the PCIe adapter 300 of FIG. 3A or 402 of FIG. 4A. The PCIe card 200 of FIG. 2 is configured to be electronically connected to the PCIe connector 500. As shown in FIG. 5A, the PCIe connector 500 includes second contacts 502 and a second housing structure 504 that encloses the second contacts 502. In some implementations, a number of the second contacts 502 of the PCIe connector 500 is no greater than a number of the first contacts 302 of the PCIe adapter 300 of FIG. 3A. the number of the second contacts 502 of the PCIe connector 500 can vary depending on applications. In a first example, the PCIe connector 500 can be used to connect a PCIe X1 device, where the number of the second contacts 502 is 36. In a second example, the PCIe connector 500 can be used to connect a PCIe X16 device, where the number of the second contacts 502 is 164. In both examples, the number of the first contacts of the PCIe adapter can be 164, where second contacts 502 of the PCIe connector 500 in the first example only in contact with a portion of the first contacts of the PCIe adapter. In some implementations, the PCIe card 200 of FIG. 2 is electrically coupled to the computer board 100a of FIG. 1A through the first contacts 302 of the PCIe adapter 300 of FIG. 3A and the second contacts 502 of the PCIe connector 500.

In some implementations, as shown in FIG. 5A, the second contacts 502 of the PCIe connector 500 are arranged into two rows extending along a first direction (e.g., the X direction). The two rows of the second contacts 502 are separated from each other along a second direction (e.g., the Y direction) perpendicular to the first direction.

FIG. 5B is a side view of a second contact 502 of the example PCIe connector 500. As shown in FIG. 5B, the second contact 502 includes a first receptor 506, a conductive layer 508, and a second receptor 510 that are arranged along a third direction (e.g., the Z direction) perpendicular to the first direction and the second direction. The second receptor 510 can include a first part and a second part that are separated and isolated from each other, and each of the first part and the second part is in contact with the conductive layer 508. The first part and the second part can form a cavity for receiving a corresponding second end 408 of a first contact 406 of a PCIe adapter 402. In some implementations, as shown in FIG. 5B, the first receptor 506 and the second receptor 510 are connected to opposite ends of the conductive layer 508 along the third direction. In some implementations, as shown in FIG. 5A, conductive layers 508 of different second contacts 502 are isolated from each other.

In some implementations, the conductive layer 508 of the second contact 502 includes a conductive material (e.g., Cu). The first receptor 506 of the second contact 502 includes a first insulating material, and the second receptor 510 of the second contact 502 includes a second insulating material. In some implementations, the first insulating material and the second insulating material are different from each other. For example, the first insulation material can be ceramic, and the second insulating material can be plastic. In some implementations, the first insulating material can be same as the second insulating material. For example, both the first insulating material and the second insulating material can be plastic.

In some implementations, the connection pins 202 of the PCIe card 200 of FIG. 2 is configured to be connected to the first receptors 506 of the second contacts 502 of the PCIe connector 500, such that each of the connection pins 202 of the PCIe card 200 is in contact with a corresponding conductive layer 508 of the second contact 502 of the PCIe connector 500. The second ends (e.g., 308b, 408b) of the first contacts (e.g., 302 or 406) of the PCIe adapter (e.g., 300 or 402) can be inserted into the second receptors 510 to be in contact with the conductive layers 508 of the second contacts 502, such that each of the connection pins 202 of the PCIe card 200 can be electrically coupled to a corresponding second end of the first contact of the PCIe adapter through the corresponding conductive layer 508 of the second contact 502 of the PCIe connector 500.

FIG. 6A-6B show steps of assembling a PCIe connector with a PCIe adapter.

FIG. 6A illustrates step 600a. At step 600a, a PCIe adapter 602 is mounted onto a PCIe slot 604. In some implementations, the PCIe adapter 602 is similar to, or same as the PCIe adapter 300 of FIG. 3 or 402 of FIG. 4A. In some implementations, the PCIe slot is similar to, or same as, the PCIe slot 100b of FIG. 1B. The PCIe adaptor includes a first contact 606 having a first end 608a in contact with a contact pad 610 of the PCIe slot 604 and a second end 608b extends in the third direction.

A second contact 612 of a PCIe connector 614 is aligned with the second end 608b of the first contact 606 of the PCIe adapter 602. The second contact 612 includes a first receptor 616, a conductive layer 618, and a second receptor 620 arranged along the third direction, where the conductive layer 618 is between the first receptor 616 and the second receptor 620. In some implementations, as shown in FIG. 6A, the second receptor 620 of the second contact 612 of the PCIe connector 614 has a female structure, and the second end 608b of the first contact 606 of the PCIe adapter 602 has a male structure. In some implementations (not shown in FIG. 6A), the second receptor 620 of the second contact 612 of the PCIe connector 614 has a male structure, and the second end 608b of the first contact 606 of the PCIe adapter 602 has a female structure.

FIG. 6B illustrates step 600b. At step 600b, a user (e.g., a human hand or a robot hand) can connect the PCIe connector 614 to the PCIe adapter 602, e.g., by pushing down the PCIe connector 614 onto/into the PCIe adapter 602 along the third direction. As shown in FIG. 6B, the second receptor 620 of the second contact 612 is configured to be connected to a corresponding second end 608b of the first contact 606 of the PCIe adapter 602. In some implementations, the conductive layer 618 of the second contact 612 is configured to be electrically connected to the corresponding second end 608b of the first contact 606 of the PCIe adapter when the second receptor 620 is connected to the corresponding second end 608b of the first contact 606.

In some implementations, the PCIe connector 614 can be separated from the PCIe adapter 602 by a user (e.g., a human hand or robot hand), e.g., by taking the second receptors 602 of the second contacts 612 of the PCIe connector 614 away from the second ends 608b of the first contacts 606 of the PCIe adapter 602. The separation of the PCIe connector 614 from the PCIe adapter 602 simplifies a process to maintain or fix a faulty PCIe connector 614.

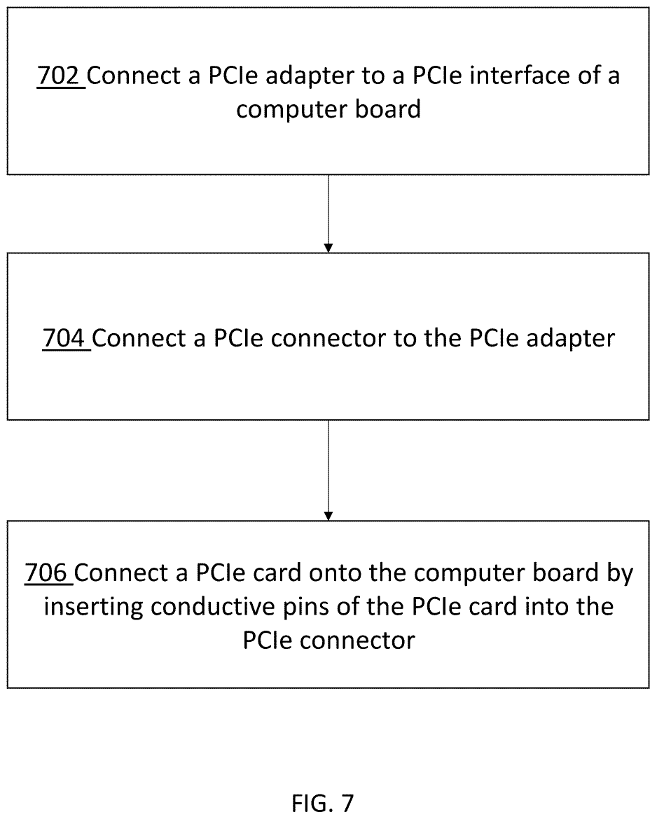

FIG. 7 is a flowchart of an example process 700 of a method for assembling a PCIe card on a computer board.

At operation 702, a PCIe adapter (e.g., the PCIe adapter 300 of FIG. 3A or 402 of FIG. 4A) is connected to a PCIe interface (e.g., the PCIe slot 106 of FIG. 1A or the PCIe slot 100b of FIG. 1B) of a computer board (e.g., the computer board 100a of FIG. 1).

At operation 704, a PCIe connector (e.g., the PCIe connector 500 of FIG. 5A) is connected to the PCIe adapter.

At operation 706, a PCIe card (e.g., the PCIe card 200 of FIG. 2) is connected onto the computer board by inserting conductive pins (e.g., the connection pins 202 of FIG. 2) of the PCIe card into the PCIe connector.

In some implementations, connecting the PCIe adapter to the PCIe interface of the computer board includes soldering first contacts (e.g., the first contacts 302 of FIG. 3A) of the PCIe adapter to corresponding contact pads (e.g., the contact pads 108 of FIG. 1B) of the PCIe interface of the computer board, such that the first contacts of the PCIe adapter are electrically connected to the corresponding contact pads of the PCIe slot of the computer board.

In some implementations, connecting the PCIe adapter to the PCIe interface of the computer board further includes soldering two connection structures (e.g., the two connection structures 304 of FIG. 3A) of the PCIe adapter to the PCIe interface of the computer board to secure the PCIe adapter onto the PCIe slot.

In some implementations, connecting the PCIe connector to the PCIe adapter includes inserting each of the first contacts of the PCIe adapter into a corresponding receptor (e.g., the second receptor 510 of FIG. 5B) of a second contact (e.g., the second contact 502 of FIG. 5B) of the PCIe connector, where the first contact of the PCIe adapter is electrically connected to a corresponding conductive layer (e.g., the conductive layer 508 of FIG. 5B) of the second contact of the PCIe connector.

In some implementations, each of the conductive pins of the PCIe card is electrically coupled to a corresponding first contact of the PCIe adapter through the corresponding conductive layer of the second contact of the PCIe connector.

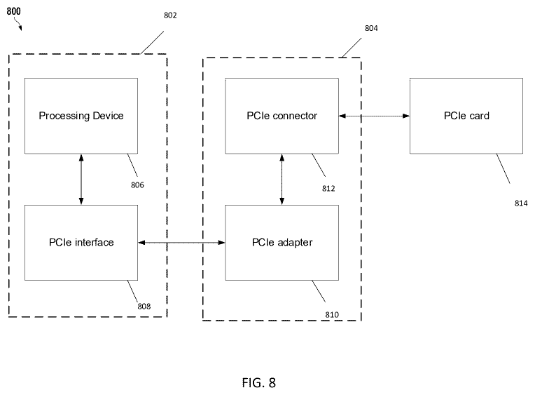

FIG. 8 illustrates a block diagram of a computer system 800. The computer system 800 can be a server computer system. As shown in FIG. 8, the system 800 can include a computer board 802 and a PCIe device 804 (e.g., the PCIe card 200 of FIG. 2). In some implementations, the computer board 802 can be a motherboard of a server computer. The computer board 802 includes at least one processing device 806 and at least one PCIe interface 808. In some implementations, the processing device 806 can be a CPU (e.g., the CPU 104 of FIG. 1A), and the PCIe interface 808 can be a PCIe slot (e.g., the PCIe slot 106 of FIG. 1A). In some implementations, the processing device 806 is coupled to the PCIe interface 808, where the processing device 806 is configured to control the PCIe interface 808.

The PCIe device 804 includes a PCIe adapter 810 (e.g., the PCIe adapter 300 of FIGS. 3A-3C or 402 of FIG. 4A) that is configured to be electronically connected to the PCIe interface 808 of the computer board 802. In some implementations, the PCIe device 804 further includes a PCIe connector 812 (e.g., the PCIe connector 500 of FIGS. 5A, 5B) that is configured to be electronically connected to the PCIe adapter 810 and pluggable into or from the PCIe adapter 810.

In some implementations, the computer system 800 further includes a PCIe card 814. The PCIe card 814 is configured to be electronically connected to the PCIe connector 812. In some implementations, the PCIe card 814 is electrically coupled to the processing device 806 of computer board 802 through the PCIe connector 812 and the PCIe adapter 810. In some implementations, the processing device 806 is configured to control the PCIe card 814 through the PCIe interface 808, the PCIe adapter 810, and the PCIe connector 812.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results.

Accordingly, the previously described example implementations do not define or constrain the present disclosure. Other changes, substitutions, and alterations are also possible without departing from the scope of the present disclosure.

What is claimed is:

1. A device, comprising:
a peripheral component interconnect express (PCIe) connector configured to be electronically connected to a peripheral component interconnect express (PCIe) card; and
a PCIe adapter configured to be electronically connected to the PCIe connector, wherein the PCIe adapter is further configured to be electronically connected to a computer board.

2. The device of claim 1, wherein the PCIe adapter comprises first contacts, and
wherein a first contact comprises a first end and a second end along a first direction, and wherein the first end of the first contact is configured to be electronically connected to a contact pad of the computer board, and the second end of the second contact is configured to be electrically connected to a contact pad of the PCIe connector.

3. The device of claim 2, wherein the first end of the first contact extends along a second direction different from the first direction.

4. The device of claim 2, wherein the PCIe adapter further comprises:
two connection structures on opposite ends of the PCIe adapter along a second direction perpendicular to the first direction; and
a first housing structure surrounding the first contacts and the two connection structures.

5. The device of claim 4, wherein the two connection structures are configured to secure the PCIe adapter on the computer board.

6. The device of claim 4, wherein the first contacts comprise a conductive material, and wherein the first housing structure comprises an insulating material.

7. The device of claim 2, wherein a number of the first contacts is in a range between 16 to 164.

8. The device of claim 2, wherein the first contacts are arranged into two rows extending along a second direction, and the two rows are separated from each other along a third direction perpendicular to the first direction and the second direction.

9. The device of claim 2, wherein the PCIe connector comprises second contacts, and
wherein a second contact comprises a first receptor, a conductive layer, and a second receptor that are arranged along the first direction, wherein conductive layers of the second contacts are isolated from each other, and wherein the first receptor and the second receptor are connected to opposite ends of the conductive layer along the first direction.

10. The device of claim 9, wherein a number the second contacts of the PCIe connector is no greater than a number of the first contacts of the PCIe adapter.

11. The device of claim 9, wherein the conductive layer of the second contact comprises a conductive material, and wherein the first receptor of the second contact comprises a first insulating material, and the second receptor of the second contact comprises a second insulating material.

12. The device of claim 9, wherein the second receptor of the second contact is configured to be connected to a corresponding second end of the first contact of the PCIe adapter, and
wherein the conductive layer of the second contact is configured to be electrically connected to the corresponding second end of the first contact of the PCIe adapter when the second receptor is connected to the corresponding second end of the first contact.

13. The device of claim 12, wherein the second receptor of the second contact has a female structure, and the second end of the first contact has a male structure.

14. The device of claim 9, wherein the PCIe card comprises a plurality of connection pins, and wherein first receptors of the second contacts of the PCIe connector are configured to be connected to the plurality of connection pins of the PCIe card.

15. The device of claim 14, wherein each of the plurality of connection pins of the PCIe card is in contact with a corresponding conductive layer of the second contact of the PCIe connector, and
wherein the PCIe card is electrically coupled to the computer board through the first contacts of the PCIe adapter and the second contacts of the PCIe connector.

16. A method, comprising:
connecting a PCIe adapter to a PCIe interface of a computer board;
connecting a PCIe connector to the PCIe adapter; and
connecting a PCIe card onto the computer board by inserting conductive pins of the PCIe card into the PCIe connector.

17. The method of claim 16, wherein connecting the PCIe adapter to the PCIe interface of the computer board comprises:
soldering first contacts of the PCIe adapter to corresponding contact pads of the PCIe interface of the computer board, such that the first contacts of the PCIe adapter are electrically connected to the corresponding contact pads of the PCIe slot of the computer board.

18. The method of claim 17, wherein connecting the PCIe connector to the PCIe adapter comprises:
inserting each of the first contacts of the PCIe adapter into a corresponding receptor of a second contact of the PCIe connector, wherein the first contact of the PCIe adapter is electrically connected to a corresponding conductive layer of the second contact of the PCIe connector.

19. The method of claim 18, wherein each of the conductive pins of the PCIe card is electrically coupled to a corresponding first contact of the PCIe adapter through the corresponding conductive layer of the second contact of the PCIe connector.

20. A system comprising:
a computer board having a PCIe interface; and
a PCIe device comprising:
a PCIe connector configured to be electronically connected to a PCIe card; and
a PCIe adapter configured to be electronically connected to the PCIe connector,
wherein the PCIe adapter is further configured to be electronically connected to the PCIe interface of the computer board.
